(19) United States
(12) Patent Application Publication
(10) Pub. No.: US 2014/0282756 A1
(43) Pub. Date: Sep. 18, 2014

(54) METHOD AND APPARATUS FOR PROVIDING TRICK-PLAY CAPABILITY WHEN PRESENTING LINEAR CONTENT

(71) Applicant: GENERAL INSTRUMENT CORPORATION, Horsham, PA (US)

(72) Inventors: Samuel H. Reichgott, Coopersburg, PA (US); Gordon S. Landis, Stow, MA (US)

(73) Assignee: GENERAL INSTRUMENT CORPORATION, Horsham, PA (US)

(21) Appl. No.: 13/832,262

(22) Filed: Mar. 15, 2013

(51) Int. Cl. H04N 21/472; H04N 21/41; H04N 21/6587

(52) U.S. Cl. CPC H04N 21/47217; H04N 21/6587; H04N 21/4135
USPC 725/88

(57) ABSTRACT

A method of outputting video to a display is provided in which an incoming signal of linear content as delivered from a service provider on a tuned channel is decoded with a first electronic device and a corresponding video signal is output to an associated display for presentation of the linear content. Information of the tuned channel is transmitted to a separate second electronic device having a time shift buffer for use in recording the incoming signal of the linear content. When a trick-play request is received by the first electronic device for the linear content, the first electronic device ceases outputting the video signal corresponding to the incoming signal as delivered from the service provider and switches to outputting a video signal corresponding to streamed content received from the time shift buffer of the second electronic device in a manner enabling trick-plays to be accomplished.

### BACKGROUND

A digital video recorder (DVR) box having a mass storage unit (MSU) (e.g., a hard disk drive) is one type of Internet Protocol (IP) enabled set-top box (STB), and a non-DVR box which does not have a MSU is another type of Internet Protocol (IP) enabled set-top box (STB). When receiving linear content, for example, a live TV broadcast, DVR type boxes can perform so-called trick-plays (e.g. pause, rewind, fast-forward, slow motion, instant replay, etc.) by recording linear content to the MSU and using the MSU as a time-shift buffer (TSB) during playback to alter the presentation of the content. In contrast, non-DVR type boxes cannot offer trick-play capabilities, by themselves, since they have no recording capability.

In some home network configurations, a DVR type box receiving content can provide such content to a non-DVR type box using IP streaming techniques. Such a configuration permits the non-DVR type box to accomplish trick-plays by controlling the streaming content via the capabilities of the DVR type box. For example, when the user of the non-DVR box requests a trick-play operation, the request is forwarded to the DVR type box, and the DVR type box uses its TSB to affect the trick-play operation. This configuration in which a non-DVR box receives streamed content via a DVR type box is typically referred to as a so-called “gateway configuration” and the DVR type box may be referred to as a “whole home DVR”.

The gateway configuration as described above necessarily requires an amount of time or delay before content presentation begins on the display associated with the non-DVR type box. As a stand-alone unit, a non-DVR type box can typically begin presenting linear content received, for instance, on a quadrature amplitude modulation (QAM) channel or an IP multicast in about one to two seconds dependent only on the stream contents and the processing efficiency of the box. Thus, a viewer of television programs that frequently surfs channels is accustomed to this amount of delay. However, in the gateway configuration described above, additional latency is necessarily added due to the extra time needed for content buffering and IP streaming processes. This results in several seconds of additional delay before content presentation can begin on the display associated with the non-DVR type box when streaming content from a DVR type box. In this case, the aggregate delay may be unacceptable to users who are accustomed to faster tuning times typical for a stand-alone set-top box.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a schematic view of a gateway configuration in accordance with an embodiment.

FIG. 2 is a schematic view of a control loop for refining synchronization between content with delay due to streaming from a gateway DVR device and corresponding content without such delay in accordance with an embodiment.

FIG. 3 is a flowchart of process steps in accordance with an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

According to an embodiment disclosed herein, a method of outputting video signals to a display for presentation of content with minimal delay is provided. An incoming signal of linear content as delivered from a service provider on a tuned channel is decoded with a first or local electronic device and a video signal corresponding to the incoming signal as delivered from the service provider is initially output to an associated display for presentation of the linear content with minimal delay. In addition, information of the tuned channel is transmitted from the first or local electronic device to a separate second or remote electronic device having a mass storage unit providing a time shift buffer for use in initiating recording of the incoming signal of the linear content on the tuned channel in the time shift buffer of the second electronic device. When a trick play request is received by the first or local electronic device for the linear content, the first or local electronic device ceases outputting the video signal corresponding to the incoming signal as delivered from the service provider and switches to outputting a video signal corresponding to streamed content received by the first or local electronic device from the time shift buffer of the second or remote electronic device in a manner enabling trick-plays to be accomplished.

According to another aspect of the above embodiment, an electronic device for outputting video signals to an associated display is provided. The electronic device includes a presentation control module for receiving channel-change requests and trick-play requests from a user and for communicating information concerning channel-change requests and trick play requests to a separate device. In one embodiment, the electronic device includes a first decoder configured to receive and decode an incoming signal of linear content on a tuned channel in a form as delivered from a service provider and to output a video signal corresponding to the incoming signal and a second decoder configured to receive streamed content of the tuned channel via the separate device. As an alternative, the electronic device can utilize a single decoder having an input that is configured to be switched to receive either the incoming signal or the streamed content. Further, the electronic device includes a selector controlled by the presentation control module for causing one of the video signals corresponding to the incoming signal or the streamed content to be output for display. For example, the presentation control module may cause the selector to establish a connection to a first decoder following a receipt of each channel-change request and to cause the selector to establish a connection to a second decoder after receiving a first trick-play request following each channel-change request. Alternatively, the selector may switch the source of the input signal to a single decoder.

The above embodiments are able to address latency issues that can occur in a home gateway/whole home DVR type device arrangement to enable trick-play services, e.g. pause live TV, by non-DVR capable set tops (or media extenders). Here, the first or local electronic device described above can be a non-DVR type set top box being used by a viewer, and the separate second or remote electronic device described above may be a DVR type set top box or like gateway or whole home device.

In some schemes, the DVR is necessarily involved at each channel change. Thus, the following steps are required to occur before presentation of content following a channel-change request: the DVR must tune to the requested program; the DVR must begin recording; the DVR must wait until it has sufficient content buffered; and then the DVR must establish a streaming session with the client non-DVR capable box before the viewer is able to begin seeing video on an associated display following a channel-change request. Each of these steps can add a second or two of delay, and these delays are a common complaint in user reviews of DVR extender-type products. However, according to the embodiments disclosed herein, the non-DVR set top tunes to the requested channel immediately without delay via QAM or IP delivery and does not rely on streamed content forwarded from the DVR until after a trick-play is requested.

Thus, the non-DVR set top immediately tunes directly to the requested channel following a channel-change request to quickly begin displaying the linear content received from the service provider on an associated display (i.e., in a manner excluding any gateway DVR action that might provide delays) and also promptly establishes a DVR session with the gateway DVR device to initiate recording in the background. With this process, the viewer does not have to wait for DVR session setup to complete before seeing video following a channel-change. Thus, there is no delay in presentation of content experienced by the viewer beyond that traditionally experienced.

In the background while the viewer is viewing content, the non-DVR set top begins to receive content streamed from the gateway DVR with delays for such processes as discussed above. However, the streamed content arriving and received from the gateway DVR is initially disregarded by the non-DVR set top and only is utilized at a time when the viewer requests a first trick-play following a channel change. At this time, the non-DVR set top switches its output without delay to the corresponding frame of the video in the content streamed, or a closely located frame, from the gateway DVR with no delay ever being experienced by the viewer. From this point forward (until the next channel-change request is received), the non-DVR set top box outputs the streamed content to the associated display for viewing by the viewer with trick-play capabilities.

The above arrangement can be implemented in a Digital Living Network Alliance (DLNA) environment with extensions made to DLNA standards. A device implementing this technique would be readily detectable by examining the DLNA command stream. Further, it will be understood by a person having ordinary skill in the art that the conventional term “set-top box” as used herein should not be construed to limit the physical placement or configuration of such a device. For example, a set-top box should neither be limited to a device that is enclosed in a box, nor should it be limited to a device positioned on top of a television set.

Also, for purposes of this disclosure, linear content refers to scheduled content such as traditional broadcast television content or programs that are scheduled to start at a predetermined time. For instance, a television program scheduled to air from 8 PM to 9 PM. Such content is typically non-interactive and may be referenced as live-TV. Further, trick-plays generally include operations such as pause, play, rewind, fast forward, slow motion (forward or reverse), and instant replay which are operations typically associated with recorded content, not live-TV.

A gateway configuration according to an embodiment is shown in FIG. 1 and includes a non-DVR box 10 and a DVR box 12. The boxes 10 and 12 may be connected via a home network or the like but are otherwise separate. Thus, the boxes 10 and 12 may be located within the same room within the home or may be located in different rooms. Both boxes 10 and 12 receive linear content (i.e., tuned content) in the form of an input signal delivered via a service provider (see input lines 14) and have a tuner, demodulator, and/or cable card module 16 and 18, respectively, for necessary tuning and processing of such input signal.

A difference between the non-DVR box 10 and the DVR box 12 is that the DVR box 12 has a mass storage unit for use as a time shift buffer (TSB) 20 for recording content whereas the non-DVR box 10 does not. It should be understood that the performance of trick-plays on linear content requires a time shift buffer and the ability to record and buffer content.

Another difference is that the non-DVR box 10 includes a presentation control module 22 which enables the non-DVR box to receive channel-change requests and trick-play requests locally or via remote control. The presentation control module communicates via link 24 to the tuner 16 to tune to a selected channel provided by a service provider and communicates via link 26 (such as via a home network, wireless signal or the like) with the DVR box 12. Communications with the DVR box 12 can provide information concerning a channel-change or a trick-play request. For this purpose, the DVR box 12 includes a streaming content module 28 that includes a communication link 30 to its tuner 18 and a communication link 32 to its TSB 20.

In the gateway configuration of FIG. 1, a viewer controlling a display of video via use of the non-DVR box 10 may utilize the non-DVR box 10 to implement a channel-change operation (see step 54 in FIG. 3). When the tuned linear content of the channel requested is only available on a QAM channel, the non-DVR box 10 having a resident QAM tuner 16 uses conventional QAM tuning to affect the channel change (see step 56 in FIG. 3) and promptly decodes (see step 58 in FIG. 3) and presents the linear content received directly from the QAM channel. Here, the incoming signal from the service provider is processed via a first decoder 34 and output by the non-DVR box 10 via a video display output module 36 to an associated display (not shown) for the quickest possible presentation of the content on the display to the user (see step 60 in FIG. 3). Thus, the user requests a channel-change and quickly sees the tuned content of the channel selected with minimal delay.

Alternatively, when the tuned linear content received from the service provider is only available on an IP multicast channel, the non-DVR box 10 joins the multicast group and presents the linear content as received directly from the IP multicast channel. Thus, this content is output by the non-DVR box 10 to the associated display (not shown) for the quickest possible presentation of the content on the display to the user.

As a further alternative, when the same linear content is available on both QAM and multicast IP channels and the non-DVR box 10 has a resident QAM tuner 16, a tuning policy of the non-DVR box 10 determines whether tuning is affected by QAM or multicast tuning methods based on achieving optimum content presentation latency.

In a parallel process to the above referenced tuning and presentation of linear content by the non-DVR box 10 upon a channel-change request, the non-DVR box 10 also initiates IP streaming of the desired linear content from the DVR box 12. This step may be performed before, during, or after the tuning/presentation steps described above. This step effectively reserves a tuner (or IP data path) on the DVR box 12 in preparation for a possible upcoming trick-play operation. Accordingly, the presentation control module 22 of the non-DVR box 10 transmits a control signal to the streaming content module 28 of the DVR box 12 and provides information concerning the selected channel. The content streaming module 28 causes the DVR box 12 to tune to the selected channel and begin to record/buffer the linear content of the tuned channel in the TSB 20 (see step 62 in FIG. 3).

According to one alternative, after the DVR box 12 tunes to the newly requested channel as a result of a channel-change request, the DVR box 12 begins recording the linear content, waits until it has sufficient content buffered, and then begins streaming content to a second decoder 38 of the non-DVR box 10 via a communication link 40 (see step 62 in FIG. 3). When the non-DVR box 10 receives the streamed linear content from the DVR box 12, it initially simply discards this stream (see step 64 in FIG. 3) until a first trick-play operation is requested by the user following the last channel-change request. Thus, content is quickly presented to the viewer following a channel-change request via the first decoder 34 and the streamed content from the DVR box 12 is provided to the second decoder 38 but only for use should a trick-play request be demanded. If no trick-play request is received before the next channel change request, the streamed content from the DVR box 12 is never utilized.

According to another alternative, the DVR box 12 buffers the linear content, but does not begin transmitting the streamed content to the non-DVR box 10 until a trick play is requested.

When a first trick-play operation is requested and received by the non-DVR box 10 following the last channel-change request (see step 66 in FIG. 3), the non-DVR box 10 switches its output to presenting the streamed content that is received from the DVR box 12 to the associated display. From this point until the next channel-change request, presentation of the content is from the streamed content delivered to the non-DVR box 10 from the DVR box 12 with trick-play capability provided by the components of the DVR box 12 (see step 70 in FIG. 3). When a trick-play request is received by the non-DVR box 10, the presentation control module 22 of the non-DVR box 10 communicates the request to the streaming content module 28 of the DVR box 12.

The next time a channel-change request is received (see step 54 in FIG. 3), the process starts over and the tuned content 14 via the first decoder 34 is provided to the video display output 36 and to the associated display so that only a minimal amount of delay is experienced following a channel-change operation.

As an alternative, the DVR box may be set not to cancel a session upon the non-DVR box tuning to a new channel. For example, if the DVR box has sufficient available tuners, the DVR box can be set to continue buffering a channel, even as it begins buffering a second, third or more channels. In this way, the user can channel-up, and then channel-down again, returning to the previously watched channel. If the user was already in trick-play mode on the first channel, the presentation could resume from the DVR box at its current (non-live) point.

As shown in FIG. 1, an output selector switch 42 can be used to connect the video display output 36 to the first decoder 34 or the second decoder 38. When a channel-change request is received by the presentation control module 22, the presentation control module 22 causes the selector switch 42 via link 44 to establish a connection between the first decoder 34 and the video display output 36. The selector switch 42 remains in this condition until a trick-play request is received. Upon receiving a trick play request, the presentation control module 22 causes the selector switch 42 to establish a connection between the second decoder 38 and the video display output 36 so that the streamed content from the DVR box 12 is output from the non-DVR box 10 for display. This condition is maintained until the next channel-change request is received which results in the selector switch 42 returning to connection with the first decoder 34 for purposes of quickly presenting the linear content of the newly tuned channel on the display without unnecessary delay caused by streaming via the DVR box 12.

When a viewer makes the initial trick-play request, the viewer will expect the trick-play to begin at or near the same video frame in the streamed content as was being presented from the locally tuned content. For example, if the viewer requests a pause trick-play operation and then subsequently requests play (i.e., un-pausing), the video should resume from about the same video frame where it was paused. Thus, upon switching from the tuned content provided directly from the service provider to the streamed content received from the intermediate DVR box 12, the presentational control module 22 may take steps to ensure that any offsets between the two contents are eliminated and/or reduced to an acceptable margin.

One contemplated alternative for achieving proper synchronization of the video frames upon a switch is to use a control loop to refine the streaming requests sent from the non-DVR box 10 to the DVR-box 12. This is best illustrated in FIG. 2 and in step 68 of FIG. 3. Streaming is initiated from the DVR box 12 to the non-DVR box 10 following a channel-change request via link 40 and the second decoder 38. An offset between the local time of the non-DVR box 10 and the program-start time of the tuned content 14 is identified (see step 46 in FIG. 2). Program-start time information can be ascertained, for instance, from metadata associated with the linear content program. In addition, the value of a presentation time-stamp (PTS 1) in the locally received video stream of the tuned content 14 can be identified at the above time offset (see step 48 in FIG. 2).

When a trick-play operation is requested, the value of the first PTS in the streamed content received from the DVR box 12 is identified (i.e., PTS 2). Ideally, the PTS 2 value of the streamed content would be identical to the local PTS 1 value previously marked. However, in practice, the two values are unlikely to match. Accordingly, the local and streamed PTS values are compared and the difference is used to compute an adjustment (e) to the offset for a subsequent streaming request (see steps 50 and 52 in FIG. 2). In addition, these steps may be repeated in the background while waiting for an initial trick-play request for purposes of obtaining a finer adjustment. The goal of the adjustment is to synchronize the local and streamed content, such that a streaming request with a given offset results in receipt of a predicted PTS value or one that is acceptably close to a predicted value.

Upon receiving a trick play request, the switch to presenting streaming content is made to satisfy the initial trick-play request. The locally received PTS value is identified, and if necessary, the time offset of the trick-play request. If necessary, a new streaming request is made with an offset adjusted to provide a stream with a first PTS value equal to, or slightly earlier than the local PTS value at trick-play request time. Playback is resumed from the streamed content at the point when the streamed PTS value matches the local PTS value at trick-play request time.

Of course, other methods may be utilized to make the first trick-play operate as expected. For example, it may be adequate to forgo the control loop of FIG. 2 and wait for the streamed PTS 2 value to achieve the locally received PTS 1 value. Subsequent trick-play requests for the same channel will all be relative to streamed content, so no further PTS synchronization with local content is needed until after the next channel change.

According to the embodiments disclosed herein, the user is able to experience optimum tuning times for linear content with each channel change. It should be understood, that initial powering up of the non-DVR box is considered the same as a channel-change request because the non-DVR box will need to tune to a channel following each start up operation. Further, buffered content is only presented to the viewer from the TSB after a first trick-play operation has been requested following a channel change. Thus, channel surfing by a user would not suffer unnecessary TSB buffering latency. This type of background streaming offers a fastest possible presentation of linear content on a non-DVR box while still providing for trick-play capabilities. An estimated 30% improvement in channel tuning performance, as compared to using IP streaming alone, should be capable of being provided.

Solely for purposes of example, the above referenced background streaming may be applied to existing (legacy) non-DVR QAM set-top boxes that are equipped with IP streaming capability. Such a set top box can be used in combination with a DVR box used as a linear content gateway in the home network. A specific example of a non-DVR set top box may be the high-definition, all digital DCX3200 set-top sold by Motorola Mobility, Inc., and an example of a gateway DVR box may be the Video Gateway DCX3600 sold by Motorola Mobility, Inc. Tuning times on the non-DVR box for live TV can be improved while trick-play capability is provided by the DVR box. In addition, this background streaming technique may also be applied to pure IP boxes whenever linear content is available via IP multicast.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

In addition, the above referenced devices, components, modules, decoders, equipment, boxes, tuners, demodulators, cable cards, buffers, links, switches, selectors, and the like for carrying out the above methods can physically be provided on a circuit board or within another electronic device and can include various processors, microprocessors, controllers, chips, disk drives, and the like. It will be apparent to one of ordinary skill in the art that the processors, controllers, tuners, modules, managers, and other components may be implemented as electronic components, software, hardware or a combination of hardware and software.

One of ordinary skill in the art appreciates that various modifications and changes can be made without departing from the scope of these embodiments as defined in the appended claims.

We claim:

1. A method of outputting video signals to a display, comprising the steps of:
decoding an incoming signal of linear content as delivered from a service provider with a first electronic device on a tuned channel and outputting a video signal corresponding to the incoming signal as delivered from the service provider to an associated display for presentation of the linear content;
transmitting information of the tuned channel to a separate second electronic device having a mass storage unit providing a time shift buffer for purposes of initiating recording of the incoming signal of the linear content on the tuned channel in the time shift buffer of the second electronic device;
after said decoding, outputting, and transmitting steps, receiving a trick play request with the first electronic device for the linear content; and
after said step of receiving the trick play request, ceasing said step of outputting the video signal corresponding to the incoming signal as delivered from the service provider and switching to outputting a video signal corresponding to streamed content received by the first electronic device from the time shift buffer of the second electronic device in a manner enabling trick plays to be accomplished.

2. A method according to claim 1, further comprising the step of receiving a channel change request with the first electronic device, wherein said decoding, outputting, and transmitting steps are repeated immediately following said channel change request.

3. A method according to claim 2, wherein said ceasing and switching steps are repeated after a trick play request is received following said channel change request.

4. A method according to claim 1, wherein said first electronic device is a set-top box.

5. A method according to claim 4, further comprising the steps of receiving the streamed content with the set-top box from the separate second electronic device before said step of receiving the trick play request and discarding the stream content before said step of receiving the trick play request.

6. A method according to claim 4, wherein said steps of transmitting information of the tuned channel to the separate second electronic device and recording the linear content on the tuned channel in the time shift buffer of the second electronic device are initiated before said step of receiving the trick play request, and further comprising the step of receiving the streamed content with the set-top box from the separate second electronic device only after said step of receiving the trick play request.

7. A method according to claim 4, wherein during said decoding step, the tuned channel is a QAM channel and the set-top box uses a QAM tuner to output the video signal corresponding to the incoming signal.

8. A method according to claim 4, wherein during said decoding step, the tuned channel is an IP multicast channel and the set-top box joins a corresponding multicast group to initially output the video signal corresponding to the incoming signal.

9. A method according to claim 4, wherein during said decoding step, the tuned channel is available on a QAM channel and an IP multicast channel and the set-top box selects one of the QAM channel and an IP multicast channel for use in outputting the video signal corresponding to the incoming signal as delivered from the service provider.

10. A method according to claim 4, wherein during said switching step, the video signal corresponding to the streamed content received by the set-top box from the time shift buffer of the separate second electronic device is synchronized with the video signal corresponding to the incoming signal as delivered from the service provider.

11. A method according to claim 10, wherein the video signal corresponding to the streamed content from the separate electronic device and the video signal corresponding to the incoming signal as delivered from the service provider are synchronized by comparing presentation time stamps (PTS) of video frames and determining an offset to apply between the streamed content and the incoming signal so that playback occurs from a corresponding video frame.

12. A method according to claim 4, wherein said second electronic device is selected from the group consisting of a digital video recorder (DVR), a DVR gateway device, and a whole home DVR device.

13. A method according to claim 1, wherein the trick play request is selected from the group consisting of pause, rewind, slow motion, and instant replay.

14. A method of presenting video content on a display, comprising the steps of:
receiving with a set-top box a channel change request to tune to a channel on which linear content is provided by a service provider;
after said step of receiving the channel change request, decoding an incoming signal of the linear content in a form as delivered from a service provider with the set-top box and outputting a video signal corresponding to the incoming signal to an associated display for presentation of the linear content;
transmitting information of the tuned channel from the set-top box to a remotely-located digital video recorder (DVR) gateway device having a mass storage unit providing a time shift buffer and directing the DVR gateway device to initiate recording of the incoming signal of the linear content on the tuned channel in the time shift buffer;
receiving a trick play request with the set-top box, the trick play request being selected from the group consisting of pause, rewind, slow motion, and instant replay relative to the linear content; and
after said step of receiving the trick play request, switching from outputting the video signal corresponding to the incoming signal as delivered directly from the service provider to outputting a video signal corresponding to streamed content received via the DVR gateway device to enable trick plays to be accomplished via use of the time shift buffer of the remotely-located DVR gateway device.

15. A method according to claim 14, further comprising the steps of receiving the streamed content with the set-top box from the remotely-located DVR gateway device before said step of receiving the trick play request and discarding the streamed content until after said step of receiving the trick play request.

16. A method according to claim 14, wherein said steps of transmitting information of the tuned channel to the DVR gateway device and recording the linear content on the tuned channel in the time shift buffer of the DVR gateway device are initiated before said step of receiving the trick play request, and further comprising the step of receiving the streamed content with the set-top box from the remotely-located DVR gateway device only after said step of receiving the trick play request.

17. An electronic device for outputting video signals to a display, comprising:
a presentation control module for receiving channel change requests and trick play requests and for communicating information concerning channel change requests to a separate device;
at least one decoder configured to receive an incoming signal of linear content as delivered directly from a service provider on a tuned channel and to output a video signal corresponding to the incoming signal and configured to receive streamed content of the tuned channel via the separate device and to output a video signal corresponding to the streamed content; and
a selector controlled by said presentation control module for causing the at least one decoder to output one of the video signal corresponding to the incoming signal and the video signal corresponding to the streamed content;
said presentation control module being configured to control said selector to cause output of the video signal corresponding to the incoming signal following receipt of each channel change request and to cause output of the video signal corresponding to the streamed content after receiving a first trick play request following each channel change request.

18. An electronic device according to claim 17, wherein said electronic device is a set-top box, and wherein the tuned channel is a QAM channel and the set-top box has a QAM tuner.

19. An electronic device according to claim 17, wherein said electronic device is a set-top box, and wherein the tuned channel is an IP multicast channel and the set-top box has IP streaming module for joining multicast groups.

20. An electronic device according to claim 17, further comprising a synchronization module configured to synchronize presentation time stamps (PTS) of video frames of the video signal corresponding to the incoming signal with presentation time stamps (PTS) of video frames of the video signal corresponding to the streamed content.
